(19) United States
(12) Patent Application Publication
(10) Pub. No.: US 2004/0228506 A1
(43) Pub. Date: Nov. 18, 2004

(54) Lid and housing apparatus and method or non-contact fingerprint imager

(76) Inventors: Waleed S. Haddad, San Francisco, CA (US); Danny E. Wood, Modesto, CA (US); Kevin McAllister, San Francisco, CA (US); Melvin G. Wieting, Huron, SD (US)

Correspondence Address: Everitt Beers, McNichols Randick O'Dea & Tooliatos, LLP, Suite 400, 5000 Hopyard Road, Pleasanton, CA, 94588-3348, US

(21) Appl. No.: 10/436,754

(22) Filed: May 12, 2003

(51) Int. Cl. G06K 9/00

(52) U.S. Cl. 382/124

(57) ABSTRACT

A lid and housing apparatus for containing a non-contact fingerprint imaging system and the methods for their operation. The invention includes combinations of a self-opening, pivoting lid with an aperture for positioning a finger, a trough surrounding the aperture designed to properly orient the finger over the aperture, and tactile features (such as a small bump or ridge) on the surface of the trough that aids the user in positioning the tip of the finger over the aperture. The invention also includes additional combinations of the attachment of a spring-loaded connection device between a cam on the lid and an actuator or enabler in the imaging system.

### BACKGROUND OF THE INVENTION

A. Field Of The Invention

The present invention relates to lid and housing enclosures for a non-contact fingerprint imaging system and the methods of their operation.

B. Description Of Related Art

There is a great need in today's age of electronic information for increased security and positive identification. For example, this includes reliable identification of purchasers at vendor sites and over the internet, identification of participants in other financial transactions, and identification in access control and anywhere sensitive information must be handled or transmitted. The growing field of biometrics provides one technological answer to this need for reliable identification. Biometric technologies measure and characterize some unique feature of a person's anatomy, which is then used to identify that person. A useful biometric identification method involves fingerprint imaging.

A number of biometric identification devices, including fingerprint imagers, already exist. The typical fingerprint imager involves designs that require that contact be made between the fingertip to be imaged and a surface, such as a prism or glass platen. Contact optical biometric identification devices have inherent problems, including large variations in the print pattern depending on finger moistness or oiliness, variations with finger pressure, poor prints or missing sections of the print with dry or overly wet fingers, loss of contrast due to residue, or latent prints left on the platen from prior use. In addition, there is also the security risk of identity theft due to the possibility of a user lifting any latent prints. Many of the problems with optical readers are also present with direct reading sensors because of the need to place the finger onto the platen. In addition, other problems with the direct-reading sensors include fragility (breaking when an object is dropped on the necessarily thin platen), damage due to electrostatic discharge, and high cost.

A necessary component of any biometric imaging system is the housing in which it is enclosed. Prior lids and housings for fingerprint imagers have been directed to contact devices and have not addressed the needs of a non-contact imager for correctly positioning the fingertip to be imaged in space.

C. Objects And Advantages Of The Invention

Accordingly, the objects and advantages of the present invention include:

(a) A housing and closing lid that protects the internal mechanisms of the imager from dust and extraneous light;

(b) A self-opening, pivoting lid uniquely designed to open upon insertion of a single finger alone;

(c) An aperture in the housing that properly positions the fingertip to be imaged in space;

(d) A housing structure surrounding the fingertip aperture including a trough and ridge(s), bump(s), groove(s), or other tactile features designed to guide the fingertip into its proper position;

(e) A lid designed so as to actuate or enable the imaging system upon opening; and

(f) A lid designed so as to be spring-loaded to assure closure;

### SUMMARY OF THE INVENTION

The present invention provides a new and unique lid and housing for a non-contact fingerprint imaging reader. The invention includes combinations of a self-opening, pivoting lid with an aperture for positioning a finger, a trough surrounding the aperture designed to properly orient the finger over the aperture, and a tactile feature on the surface of the trough to aid a user in positioning the tip of the finger properly over the aperture (such as a ridge on the leading edge). The invention also includes additional combinations of the attachment of a spring-loaded connection device between a cam on the lid and an actuator or enabler in the imaging system.

### BRIEF DESCRIPTION OF THE DRAWINGS

FIG. 1 is an external perspective view of an embodiment of the invention.

FIG. 2a is a perspective view of the underside of the lid of the invention.

FIG. 2b is a perspective view of the top of the lid of the invention.

FIG. 3 is a top exploded view of the invention showing how the parts are assembled.

FIG. 4 is bottom exploded view of the invention showing how the parts are assembled.

FIG. 5a is a side cut-away view of the invention showing the lid and actuator in the closed position.

FIG. 5b is a side cut-away view of the invention showing the lid and actuator in a partially open position.

FIG. 5c is a side cut-away view of the invention showing the lid and actuator in a fully open position.

FIG. 6 is a perspective view of the invention showing it in use with a fingertip inserted under the lid and over the aperture.

### DESCRIPTION OF THE INVENTION

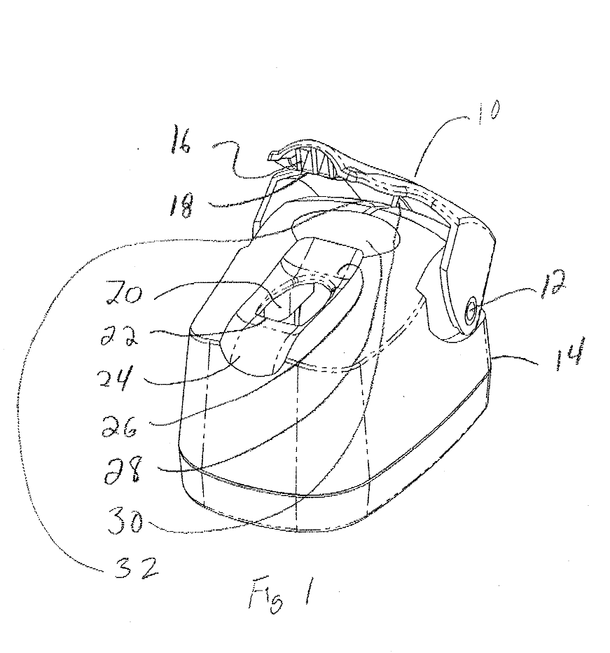

A preferred embodiment of the invention is illustrated in FIGS. 1 through 6. FIG. 1 is an external perspective view of the invention showing both the lid and the housing, with the lid in its open position. In FIG. 1, the lid 10 is pivotally connected 12 to the housing 14. The lid 10 contains on its underside an extrusion that is beveled 16 on the front side of a dam 18 that is contoured so as to match the shape of a trough 26 on the housing. An appropriately shaped cam 30 is attached to the rear underside of the lid 10 with the cam protruding into the housing through a slot 32.

The housing 14 contains an aperture 20 surrounded by a trough 26 that has a rounded leading edge 24. The aperture 20 may be shaped with a ridged leading edge 22 for aiding the user in positioning their finger properly over the aperture. The ridge tactile feedback feature is to ensure that the finger is placed far enough into the reader and that the fingertip is not placed down into the aperture. Equivalent means of tactile feedback can be used in place of, or in conjunction with the shown ridge. Other means for tactile feedback include, but are not limited to, the following: (1) small hemi-spherical, pyramidal, cubic, or otherwise shaped bumps (a single one, or a set of two or more) at the resting position of the finger tip (along the sloping section of the trough aft of the distal point of the aperture); (2) a thin rib around the edge of the aperture that can be felt by the user; (3) a series of small bumps (many possible shapes) or grooves along the sides of the trough to cue the user as to the proper rotational orientation of his/her finger (about the axis of the finger); (4) a series of bumps or ridges of increasing size, height, or width, or sequentially changing in shape at the back slope of the trough to aid users with different size fingers in finding the proper distance at which to insert their fingers; (5) a patch or patches of rough versus smooth texture in the surface of the trough; (6) knurling, or hatched grooves in one section of the trough (such as the back sloped region again); (7) a hole or holes, or an indentation or set of indentations that can be felt placed in a selected region or regions of the trough; or (8) a patch or patches or rubbery (resilient) material that can felt by the user, but can also serve to slow or stop the finger motion at the correct point as it is being inserted.

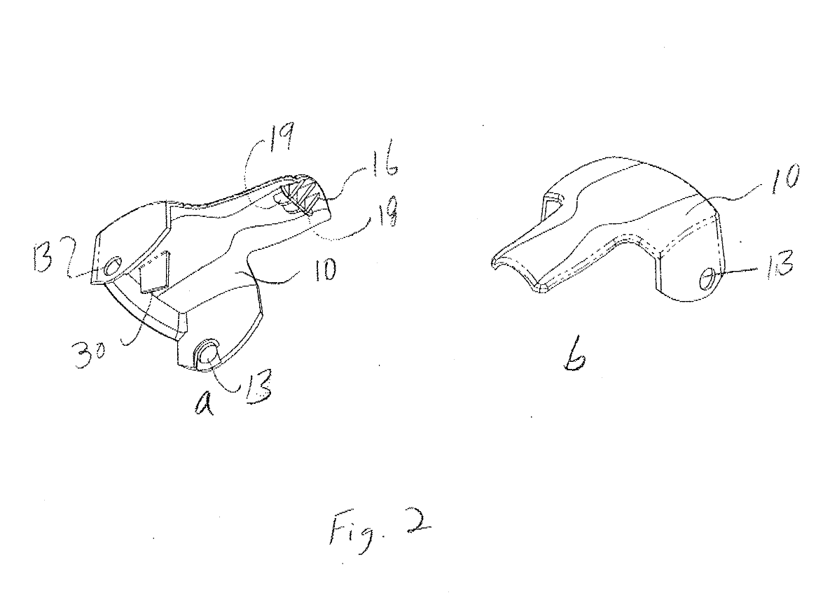

FIGS. 2a and 2b show the lid 10 separated from the housing 14. FIG. 2a is an underside view and FIG. 2b is a topside view of the lid 10. In FIG. 2a, the dam 18 is located on the forward lip of the lid with a first bevel 16 on the front of the dam and with a second bevel 19 located on the back of the dam. The cam 30 is located on the rear underside of the lid 10. The lid portion of the pivot connections 13 are located on the sides of the lid 10.

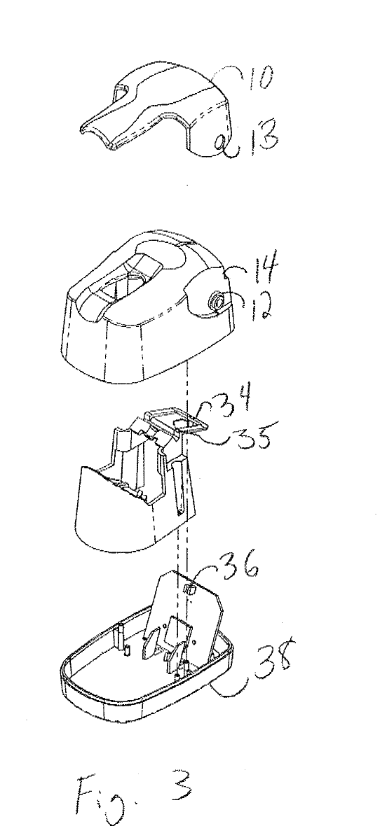

In FIG. 3, a top exploded view of the lid 10 and housing 14 are shown. The pivot connection holes 13 on the lid 10 snap over the pivot posts 12 located on the housing 14. A cam follower, spring-loaded device 34 touches against the cam 30 (shown in FIGS. 1 and 2a). The cam follower 34 contains an appendage 35 that slides into an optical interrupter detection device 36. The housing 14 snaps onto a base 38.

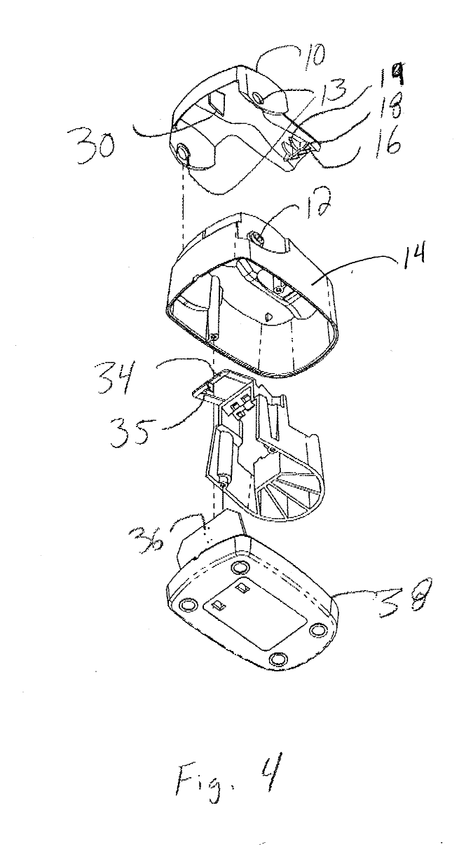

In FIG. 4, a bottom exploded view of the lid 10 and housing 14 are shown. The lid 10 contains the cam 30, which, when assembled, meets the cam follower 34. The lid 10 contains pivot holes 13, which, when assembled, snap over the pivot posts 12. The lid 10 contains on its leading edge the dam 18 with bevels on the dam's leading 16 and rearward 19 sides. The cam follower 34 has an appendage 35 that is moved into the detector 36 by the combined action of the cam 30 and the cam follower 34 when the lid 10 is rotated.

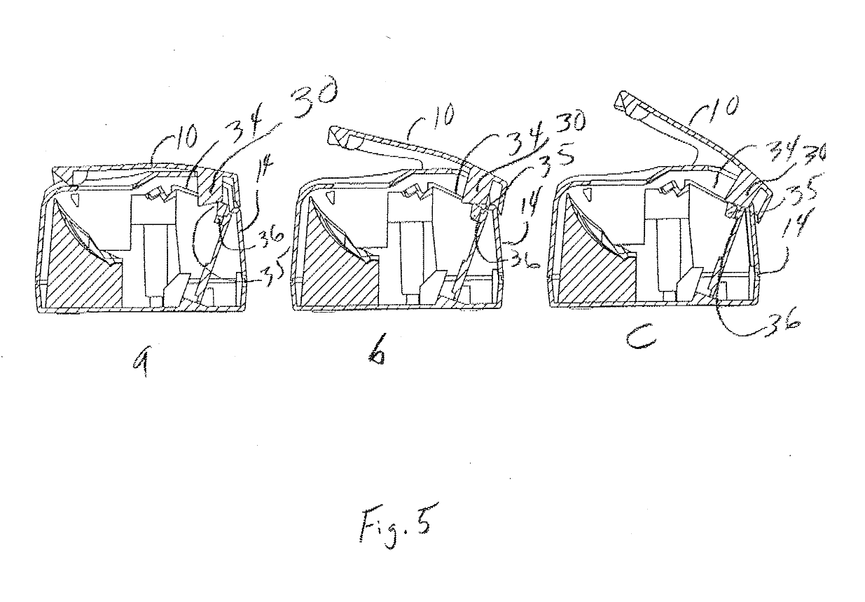

FIGS. 5a, 5b, and 5c are side cut-away views of the invention showing the lid 10 in operation. As the lid 10 is opened, the cam 30 causes the cam follower 34 to move, which causes the appendage 35 to move into the detector 36.

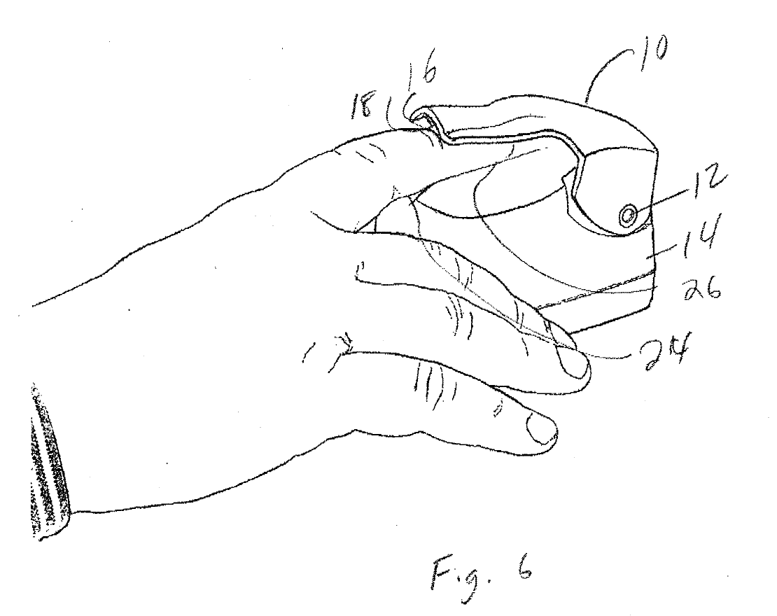

FIG. 6 shows the invention in operation, with a fingertip inserted under the lid and over the aperture 20. In operation, the finger is slid into the end of the trough 26, contacting both the beveled edge 16 of the dam 18 on the lid 10 and the beveled edge 24 of the trough 26 on the housing 14. This causes the lid 10 to pivot upwards about its pivot connection 12. As described in the preceding paragraph, this movement in turn causes the cam 30 to actuate the cam follower 34.

In operation, as shown in FIG. 1, the shape of the trough 26, together with the shape of the aperture 20 and its leading edge 22 guide the finger into a correct position for imaging. The end of the trough 26 has a further extension 28 allowing the invention to accommodate a long fingernail.

The above description is of the preferred embodiment of the invention. Many of the elements of the invention as described in the preferred embodiment have equivalent means that can be readily substituted for those individual elements. Further, although the description above contains many specifics, these should not be construed as limiting the scope of the invention, but instead as merely providing illustrations of some of the presently preferred embodiments of aspects of this invention.

What is claimed is:

1. An apparatus for enclosing a fingerprint imager, the apparatus comprising:
a. a fixed housing within which the fingerprint imager is contained;
b. a lid allowing a finger to be slipped underneath to raise the lid;
c. a pivot connecting the lid to the housing allowing the lid to pivot upwards when the finger is inserted.

2. The apparatus for enclosing a fingerprint imager of claim 1, the apparatus further comprising:
a. a ramp on the underside of the leading edge of the lid.

3. The apparatus for enclosing a fingerprint imager of claim 1, the apparatus further comprising:
a. the lid placed so that gravity acts to close the lid.

4. The apparatus for enclosing a fingerprint imager of claim 2, the apparatus further comprising:
a. the lid placed so that gravity acts to close the lid.

5. The apparatus for enclosing a fingerprint imager of claim 1, 2, 3, or 4, the apparatus further comprising:
a. an aperture in the housing that is covered by the lid when in its closed position.

6. The apparatus for enclosing a fingerprint imager of claim 1, 2, 3, or 4 the apparatus further comprising:
a. a beveled ramp on the leading edge of the aperture that is tapered to match the ramp in the lid for easing the opening of the lid by the insertion of the finger.

7. The apparatus for enclosing a fingerprint imager of claim 1, 2, 3, or 4, the apparatus further comprising:
a. a spring device connected to the housing and touching the lid that provides a restoring force to assure lid closure.

8. The apparatus for enclosing a fingerprint imager of claim 5, the apparatus further comprising:
a. a spring device connected to the housing and touching the lid that provides a restoring force to assure lid closure.

9. The apparatus for enclosing a fingerprint imager of claim 6, the apparatus further comprising:
a. a spring device connected to the housing and touching the lid that provides a restoring force to assure lid closure.

10. The apparatus for enclosing a fingerprint imager of claim 5, the apparatus further comprising:
a. a trough surrounding the aperture that is shaped to properly orient the finger over the aperture.

11. The apparatus for enclosing a fingerprint imager of claim 5, the apparatus further comprising:
a. a trough surrounding the aperture that is shaped to guide the insertion of and properly orient the finger over the aperture.

12. The apparatus for enclosing a fingerprint imager of claim 10, the apparatus further comprising:
a. an extension of the trough on the edge of the aperture opposite its leading edge sufficient to accommodate a fingernail.

13. The apparatus for enclosing a fingerprint imager of claim 11, the apparatus further comprising:
a. an extension of the trough on the edge of the aperture opposite its leading edge sufficient to accommodate a fingernail.

14. The apparatus for enclosing a fingerprint imager of claim 5, the apparatus further comprising:
a. a means for positioning the tip of the finger over the aperture.

15. The apparatus for enclosing a fingerprint imager of claim 8, the apparatus further comprising:
a. a means for positioning the tip of the finger over the aperture.

16. The apparatus for enclosing a fingerprint imager of claim 11, the apparatus further comprising:
a. a means for positioning the tip of the finger over the aperture.

17. The apparatus for enclosing a fingerprint imager of claim 5, the apparatus further comprising:
a. a ridge on the leading edge of the aperture that positions the tip of the finger over the aperture.

18. The apparatus for enclosing a fingerprint imager of claim 8, the apparatus further comprising:
a. a ridge on the leading edge of the aperture that positions the tip of the finger over the aperture.

19. The apparatus for enclosing a fingerprint imager of claim 11, the apparatus further comprising:
a. a ridge on the leading edge of the aperture that positions the tip of the finger over the aperture.

20. The apparatus for enclosing a fingerprint imager of claim 1, the apparatus further comprising:
a. an actuator attached to the lid that enables image acquisition by the fingerprint imager when the lid is lifted.

21. The apparatus for enclosing a fingerprint imager of claim 7, the apparatus further comprising:
a. an actuator attached to the end of the spring device that enables image acquisition by the fingerprint imager when the lid is lifted.

22. The apparatus for enclosing a fingerprint imager of claim 1, the apparatus further comprising:
a. an actuator attached to the lid that triggers an image acquisition by the fingerprint imager when the lid is lifted.

23. The apparatus for enclosing a fingerprint imager of claim 7, the apparatus further comprising:
a. an actuator attached to the end of the spring device that triggers an image acquisition by the fingerprint imager when the lid is lifted.

24. The apparatus for enclosing a fingerprint imager of claim 1, the apparatus further comprising:
a. an actuator attached to the lid that enables an electrical circuit controlling a feature of the imager when the lid is lifted.

25. The apparatus for enclosing a fingerprint imager of claim 7, the apparatus further comprising:
a. an actuator attached to the end of the spring device that enables an electrical circuit controlling a feature of the imager when the lid is lifted.

26. The apparatus for enclosing a fingerprint imager of claim 8, the apparatus further comprising:
a. an actuator attached to the end of the spring device that enables image acquisition by the fingerprint imager when the lid is lifted.

27. The apparatus for enclosing a fingerprint imager of claim 11, the apparatus further comprising:
a. an actuator attached to the end of the spring device that triggers an image acquisition by the fingerprint imager when the lid is lifted.

28. The apparatus for enclosing a fingerprint imager of claim 11, the apparatus further comprising:
a. an actuator attached to the end of the spring device that enables image acquisition by the fingerprint imager when the lid is lifted.

29. The apparatus for enclosing a fingerprint imager of claim 13, the apparatus further comprising:
a. an actuator attached to the end of the spring device that triggers an image acquisition by the fingerprint imager when the lid is lifted.

30. The apparatus for enclosing a fingerprint imager of claim 13, the apparatus further comprising:
a. an actuator attached to the end of the spring device that enables image acquisition by the fingerprint imager when the lid is lifted.

31. The apparatus for enclosing a fingerprint imager of claim 18, the apparatus further comprising:
a. an actuator attached to the end of the spring device that triggers an image acquisition by the fingerprint imager when the lid is lifted.

32. The apparatus for enclosing a fingerprint imager of claim 18, the apparatus further comprising:
a. an actuator attached to the end of the spring device that enables image acquisition by the fingerprint imager when the lid is lifted.

33. The apparatus for enclosing a fingerprint imager of claim 19, the apparatus further comprising:
a. an actuator attached to the end of the spring device that triggers an image acquisition by the fingerprint imager when the lid is lifted.

34. The apparatus for enclosing a fingerprint imager of claim 19, the apparatus further comprising:
a. an actuator attached to the end of the spring device that enables image acquisition by the fingerprint imager when the lid is lifted.

35. The apparatus for enclosing a fingerprint imager of claim 10, the apparatus further comprising:
a. a dam across the underside of the lid that fits into the trough so as to block light and dust.

36. The apparatus for enclosing a fingerprint imager of claim 11, the apparatus further comprising:
a. a dam across the underside of the lid that fits into the trough so as to block light and dust.

37. The apparatus for enclosing a fingerprint imager of claim 7, further comprising:
a. a cam follower on the lid that touches the spring device and serves to secure the closing of the lid.

38. The apparatus for enclosing a fingerprint imager of claim 1, 2, or 3, further comprising:
a. a motorized lid that is opened by the triggering of a detection device using the interruption of a light beam.

39. The apparatus for enclosing a fingerprint imager of claim 4, further comprising:
a. a motorized lid that is opened by the triggering of a detection device using the interruption of a light beam.

40. The apparatus for enclosing a fingerprint imager of claim 6, further comprising:
a. a motorized lid that is opened by the triggering of a detection device using the interruption of a light beam.

41. The apparatus for enclosing a fingerprint imager of claim 1, 2, 3, or 4, further comprising:
a. A motorized lid that is opened by the triggering of a motion detector.

42. The apparatus for enclosing a fingerprint imager of claim 5, further comprising:
a. A motorized lid that is opened by the triggering of a motion detector.

43. The apparatus for enclosing a fingerpfint imager of claim 6, further comprising:
a. A motorized lid that is opened by the triggering of a motion detector.
